(19) United States
(12) Patent Application Publication
(10) Pub. No.: US 2009/0120180 A1
(43) Pub. Date: May 14, 2009

(54) SOLUTION METERING APPARATUS HAVING TEMPERATURE SENSING FUNCTION

(76) Inventors: YUNG-LIEH CHIEN, Chupei (TW); Ming-Yao Dong, Chupei (TW)

Correspondence Address: G. LINK CO., LTD., 3550 BELL ROAD, MINOOKA, IL, 60447, US

(21) Appl. No.: 12/013,454

(22) Filed: Jan. 13, 2008

(30) Foreign Application Priority Data
Nov. 12, 2007 (TW) 096219090

(51) Int. Cl. G01F 1/68

(52) U.S. Cl. 73/204.25

(57) ABSTRACT

A solution metering apparatus having temperature sensing function comprises a substrate; a sensor layer consisting of a first sensing member, a second sensing member, and a temperature sensing member, where the first sensing member and the second sensing member respectively have in horizontal direction a plurality of sidewardly extended parallel strip lines that are alternately arranged, and the temperature sensing member is made of equivalent resistor material and disposed on one side surface of the substrate; and a protective layer overlying the sensor layer. The solution metering apparatus makes use of the physical characteristics of fluid as measured by the sensor layer, particularly its temperature sensing member to determine temperature change based on change in resistance value.

### FIELD OF THE INVENTION

The present invention relates to a solution metering apparatus having temperature sensing function, more particularly a metering apparatus with added temperature measuring and temperature compensation functions.

### BACKGROUND OF THE INVENTION

Conventional fluid level measuring devices measure the fluid quantity. Fluid measuring devices are generally sizable and complex in structure, and hence more costly. However there is increasingly market demand for small-size and low-cost products. Take the example of fuel cell system, its applications in portable electronic devices are gaining grounds. In a fuel cell system that uses hydrogen-rich fuel (e.g. methanol) and oxygen fuel to undergo electrochemical reaction and output power, it is necessary for users to know when to replenish the fuel when fluid concentration or level becomes low. Thus it is necessary to detect the fluid fuel level and volume in the fuel container. Moreover, it is necessary to watch temperature rise in the fuel cell caused by the heat energy produced in the chemical reaction. The detection of fuel concentration and volume is typically achieved through expensive metering sensor, which is rather uneconomical when used extensively in portable electrical products. For the measurement of temperature, temperature sensors are typically non-planar, hence posing a corrosion resistance problem.

In light of the drawbacks of conventional fluid metering devices, the inventor with many years of experience in the industry aims to develop an improved fluid metering device to achieve the desired functions.

### SUMMARY OF THE INVENTION

The primary object of the invention is to provide a solution metering apparatus having temperature sensing function for measuring the fluid level or other physical characteristics of fluid in a solution storage vessel that also has a structure able to protect the circuitry of the metering apparatus.

Another object of the invention is to provide a solution metering apparatus having temperature sensing function that uses its sensing member to measure capacitance, inductance, impedance or any electric signal in the combination of such signals to obtain the corresponding physical characteristics of the solution.

Yet another object of the invention is to provide a solution metering apparatus having temperature sensing function that can be used in a fuel cell system for measuring the fluid fuel level in the fuel storage vessel of the fuel cell.

The solution metering apparatus having temperature sensing function according to the invention comprises a substrate; a sensor layer consisting of a first sensing member, a second sensing member, and a temperature sensing member, where the first sensing member and the second sensing member respectively have in horizontal direction a plurality of sidewardly extended parallel strip lines that are alternately arranged, and the temperature sensing member is made of equivalent resistor material and disposed on one side surface of the substrate; and a protective layer overlying the sensor layer, to makes use of the physical characteristics of fluid as measured by the sensor layer and protect the sensing member from the corrosion of fluid, while the temperature sensing member can determine change in temperature based on change in resistance value.

The objects, features and effects of the invention are described in detail below with embodiments in reference to the accompanying drawings.

### DESCRIPTION OF THE DRAWINGS

FIG. 1 is a partial sectional view of a first embodiment of the invention;

FIG. 2 is a partial plane view of the sensor layer in a first embodiment of the invention;

FIG. 3 is a diagram of a first embodiment of the invention in use;

FIG. 4 is a partial plane view of the sensor layer in a second embodiment of the invention;

FIG. 5 is a partial plane view of the sensor layer in a third embodiment of the invention;

FIG. 6 is a partial plane view of the sensor layer in a third embodiment of the invention;

FIG. 7 is an exploded view of the solution metering apparatus and the solution storage vessel according to a third embodiment of the invention;

FIG. 8 is a diagram of a third embodiment of the invention in use;

FIG. 9 is a partial plane view of the sensor layer in a fourth embodiment of the invention; and

FIG. 10 is a side sectional view of the solution metering apparatus according to another embodiment of the invention.

### DETAILED DESCRIPTION OF THE INVENTION

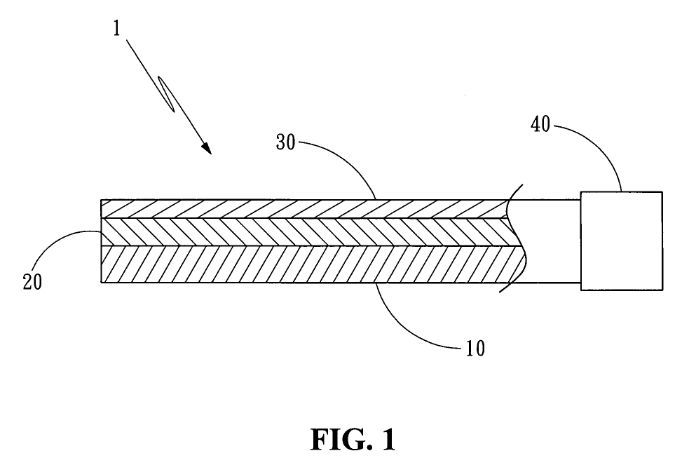

FIG. 1 is partial sectional view of a first embodiment of the invention. As shown, the invention provides a solution metering apparatus (1) having temperature sensing function, comprising at least a substrate (10), a sensor layer (20) and a protective layer (30), wherein the sensor layer (20) is sandwiched between the substrate (10) and the protective layer (30), and a connector (40) is disposed at one end of the solution metering apparatus (1) such that the physical quantity measured by the sensor layer (20) can be sent via the connector (40) to a microprocessor or an electrically connected external electrical apparatus, such as a computer.

The protective layer (30) envelops the entire substrate (10) and the outer surface of the sensor layer (20).

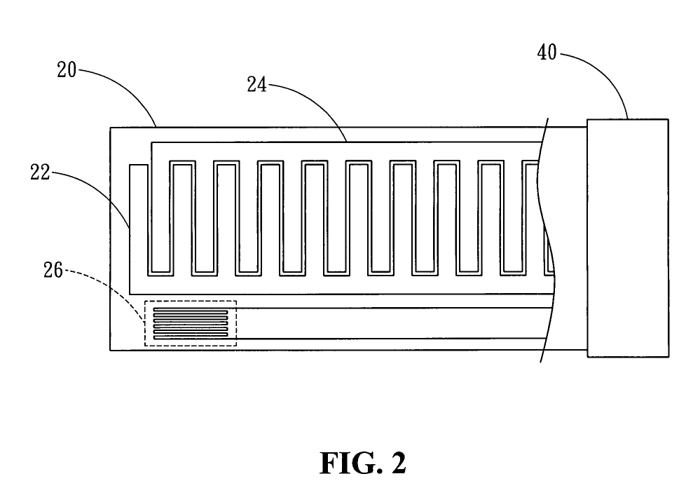

FIG. 2 is a partial plane view of the sensor layer in a first embodiment of the invention. As shown, the sensor layer (20) consists of a first sensing member (22) and a second sensing member (24) wherein the first sensing member (22) and the second sensing member (24) have respectively in horizontal direction a plurality of sidewardly extended parallel strip lines that are alternately arranged. The sensor layer (20) also comprises a temperature sensing member (26). The temperature sensing member (26) is made of equivalent resistor material, the equivalent resistor being a long lead circuit (made of aluminum, gold or copper as illustrated in this example) or a high-resistance circuit (made of nickel or chromium). The implementation of the invention is described in detail below.

The plurality of sidewardly extended strip lines in the horizontal direction of the first sensing member (22) and the second sensing member (24) are not necessarily parallel strip lines, so long as they produce capacitance effect.

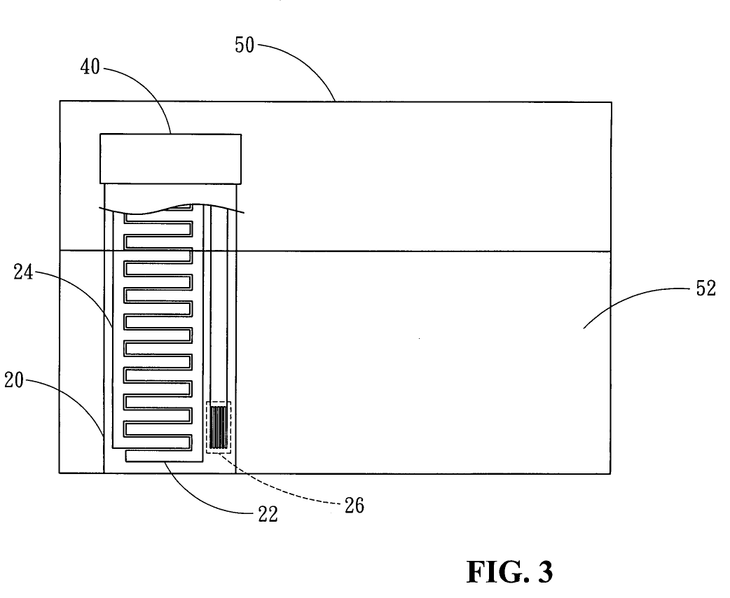

FIG. 3 is a diagram of a first embodiment of the invention in use. As shown, the solution metering apparatus (1) is disposed in a solution storage vessel (50). For example, the solution storage vessel (50) is a fuel storage vessel for storing fuel used in a fuel cell system. The solution storage vessel (50) contains solution (52), while the solution metering apparatus (1) is placed in the depth measuring space therein for measuring the height, density, concentration or other characteristics of the solution, and sends the message received through the connector (40). When the temperature in the solution storage vessel (50) changes, the temperature sensing member (26) detects the change and sends out the message through the connector (40) so as to take possible measuring error brought about by temperature change into consideration. The temperature sensing member (26) can make use of the characteristics of an electrical conductor, that is, the variation of its resistance is directly proportional to the variation of temperature. Also, with the temperature sensing member (26) being a multi-fold line, its resistance is also directly proportional to the conductive channel. Hence the starting resistance in this embodiment of the invention is relatively high. When there is temperature change, the resistance value changes proportionally. But because of the higher starting resistance, its proportional change along with temperature change will be pronounced enough to be detected. As such, the resolution of temperature change detection will be enhanced.

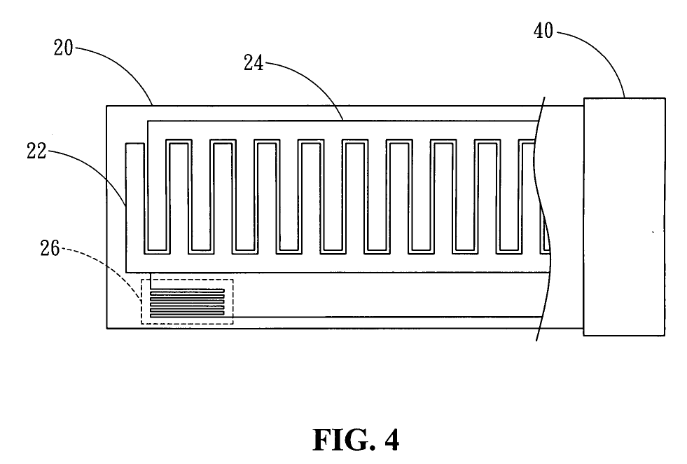

FIG. 4 is a partial plane view of the sensor layer in a second embodiment of the invention. The main difference between this embodiment and the embodiment described above is that the temperature sensing member (26) and the first sensing member (22) or the second sensing member (24) forms an electric connection. FIG. 4 shows that one end of the temperature sensing member (26) is connected to the connector (40), while its other end is connected to the first sensing member (22) such that the signal on the measurement obtained by the temperature sensing member (26) can be sent out via the electric connection between the first sensing member (22) and the connector (40).

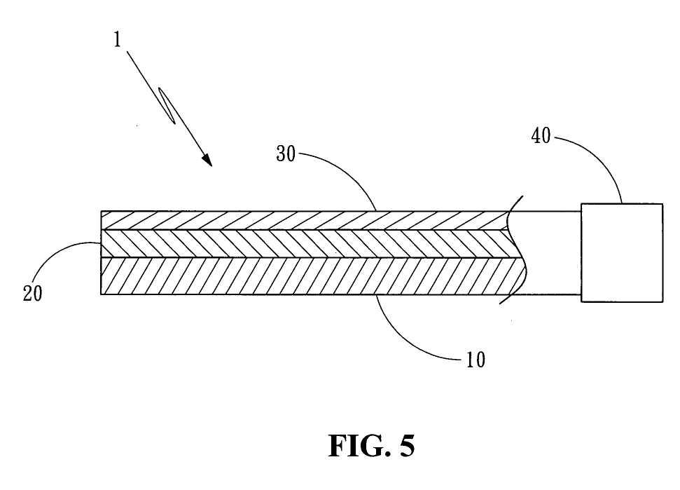

FIG. 5 is a partial plane view of the sensor layer in a third embodiment of the invention. The solution metering apparatus (1) with temperature sensing function in this embodiment is for detecting the physical state of solution in a storage vessel (50) and comprises at least a substrate (10), a sensor layer (20) and a protective layer (30), wherein the sensor layer (20) is sandwiched between the substrate (10) and the protective layer (30), and a connector (40) is disposed at one end of the solution metering apparatus (I) such that the signal on the physical quantity measured by the sensor layer (20) can be sent via the connector (40) to a microprocessor or an electrically connected external electrical apparatus, such as a computer.

The protective layer (30) envelops the entire substrate (10) and the outer surface of the sensor layer (20).

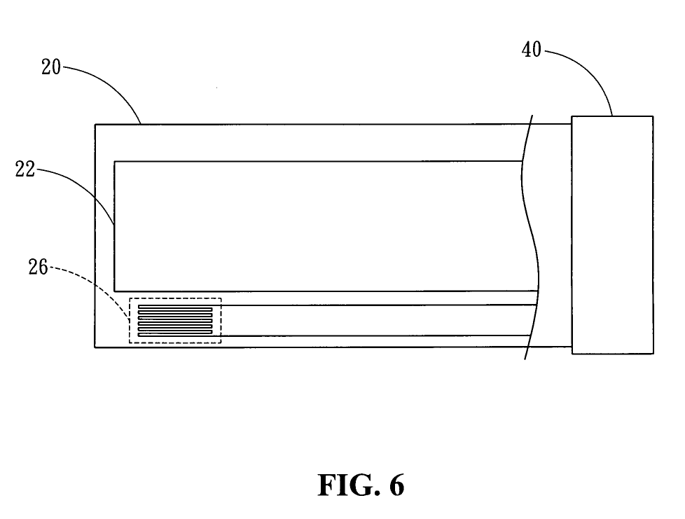

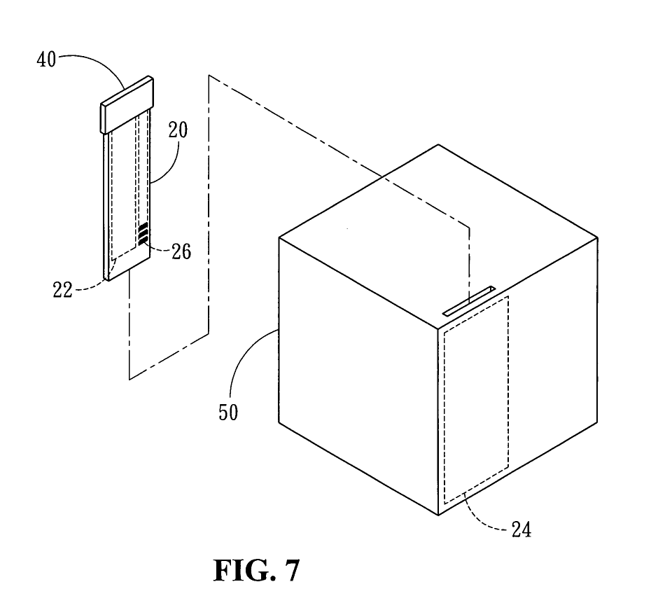

FIG. 6 is a partial plane view of the sensor layer in a third embodiment of the invention; FIG. 7 is an exploded view of the solution metering apparatus and the solution storage vessel according to a third embodiment of the invention. As shown, the sensor layer (20) consists of a first sensing member (22) and a temperature sensing member (26). A second sensing member (24) is disposed on the outer surface of the solution storage vessel (50), and electrically connected to the connector (40). The first sensing member (22) and the second sensing member (24) disposed on the solution storage vessel (50) form capacitance effect. The temperature sensing member (26) of the sensor layer (20) is made of equivalent resistor material, the equivalent resistor being a long lead circuit (made of aluminum, gold or copper as illustrated in this example) or a high-resistance circuit (made of nickel or chromium). The implementation of the invention is described in detail below.

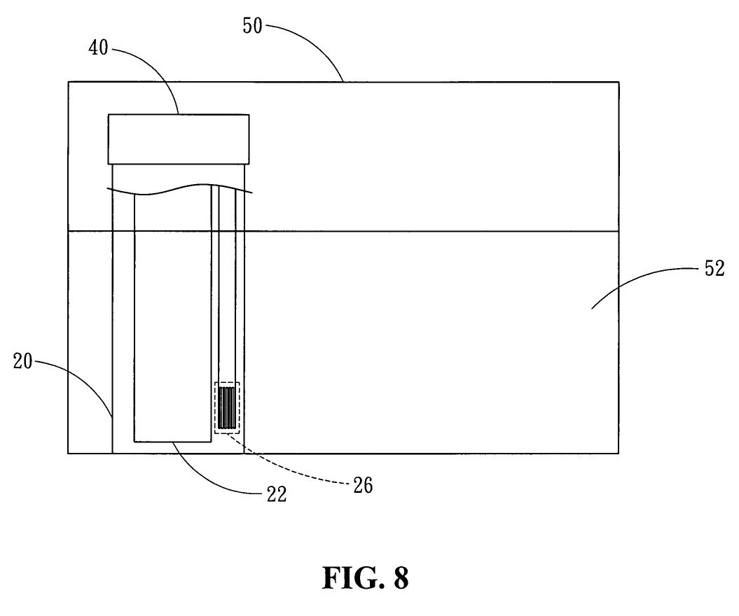

FIG. 8 is a diagram of a third embodiment of the invention in use. As shown, the solution metering apparatus (1) is disposed in a solution storage vessel (50). For example, the solution storage vessel (50) is a fuel storage vessel for storing fuel used in a fuel cell system. The solution storage vessel (50) contains solution (52), while the solution metering apparatus (1) is placed in the depth measuring space therein for measuring the height, density, concentration or other characteristics of the solution, and sends the message received through the connector (40). When the temperature in the solution storage vessel (50) changes, the temperature sensing member (26) detects the change and sends out the message through the connector (40) so as to take possible measuring error brought about by temperature change into consideration. The temperature sensing member (26) makes use of the characteristics of an electrical conductor, that is, the variation of its resistance is directly proportional to the variation of temperature. Also, the temperature sensing member (26) is made of high-resistance material. If the resistance value is high while its proportional change with temperature change remains, the value of resistance change will be pronounced enough to be detected, thereby enhancing the resolution of temperature change detection.

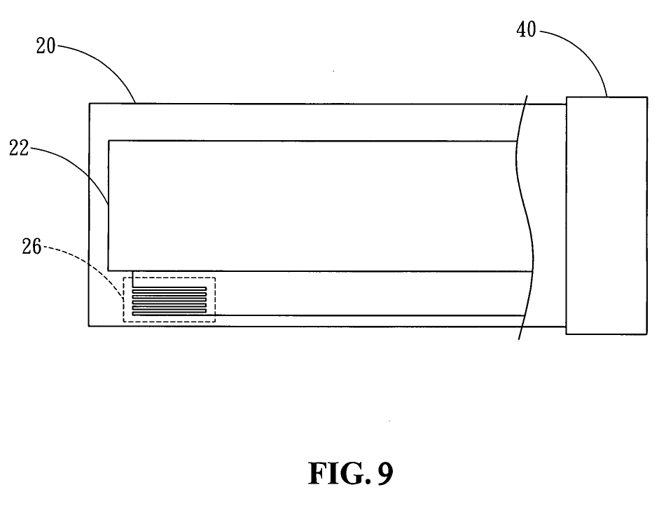

FIG. 9 is a partial plane view of the sensor layer in a fourth embodiment of the invention. The main difference between this embodiment and the embodiment described above is that the temperature sensing member (26) and the first sensing member (22) forms an electric connection. FIG. 9 shows that one end of the temperature sensing member (26) is connected to the connector (40), while its other end is connected to the first sensing member (22) such that the signal on the measurement obtained by the temperature sensing member (26) can be sent out via the electric connection between the first sensing member (22) and the connector (40).

The material for the substrate (10) and the protective layer (30) may be FR4, FR5, epoxy resin, glass fiber laminate, ceramic laminate, polymer laminate or their mixtures thereof to give the substrate (10) and the protective layer (30) corrosion resistance so as to protect the metal material in the sensor layer (20) from corrosive fluid. In addition, the aforementioned materials are materials commonly used in the industry and their processes are mature for easy manufacture of the substrate (10) and the protective layer (30).

The material for the protective layer (30) of solution metering apparatus (I) used in the fuel storage vessel should take into account protecting the lead wire of electric circuit from corrosion by the fuel. Thus the material for the protective layer (30) can be selected further from Teflon, polyethylene and non-polar material, in which Teflon can be coated onto the outer surface of protective layer (30) and substrate (10) by way of surface coating. The entire outer surface of the solution metering apparatus can also be coated with Teflon.

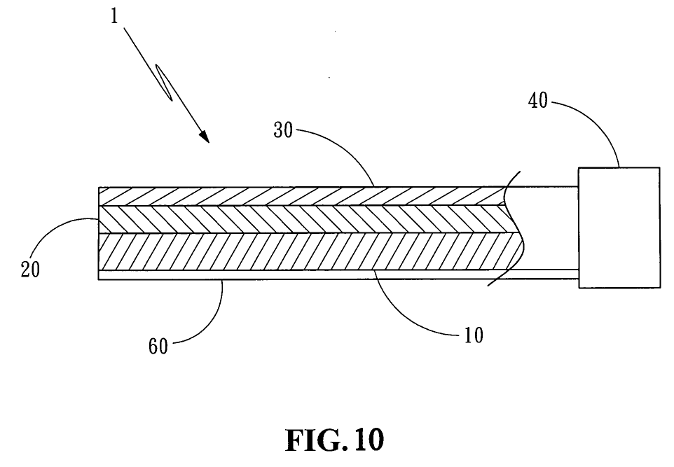

FIG. 10 is a side sectional view of the solution metering apparatus according to another embodiment of the invention. The solution metering apparatus (1) further comprises a shield layer (60), the shield layer (60) being a metal conductive layer and electrically grounded, and arranged on another side surface of the substrate (10) opposing the sensor layer (20) such that the shield layer (60) can provide an electromagnetic shield when there is any electric element in the vicinity of the solution metering apparatus (1) that might produce electromagnetic interference.

As such, the solution metering apparatus having temperature sensing function provided by the invention has added temperature measuring and temperature compensation functions. The invention possesses inventive step and meets the essential criteria for patent.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A solution metering apparatus having temperature sensing function, comprising:
a substrate;
a sensor layer, consisting of a first sensing member, a second sensing member, and a temperature sensing member, wherein the first sensing member and the second sensing member have respectively in horizontal direction a plurality of sidewardly extended parallel strip lines that are alternately arranged and form capacitance effect, whereas the temperature sensing member is made of equivalent resistor material, the sensor layer being disposed on one side surface of the substrate; and
a protective layer overlying the sensor layer.

2. The solution metering apparatus having temperature sensing function according to claim 1, wherein the sensor layer measures any of the following signals: capacitance, inductance, and impedance.

3. The solution metering apparatus having temperature sensing function according to claim 1, further comprising a connector, the connector linking the signal generated by the first sensing member, the second sensing member, or the temperature sensing member to the exterior.

4. The solution metering apparatus having temperature sensing function according to claim 1, wherein the protective layer envelops the entire substrate and the outer surface of sensor layer.

5. The solution metering apparatus having temperature sensing function according to claim 1, further comprising a shield layer, the shield layer being a metal conductive layer and electrically grounded, and disposed on another side surface of the substrate opposing the sensor layer.

6. The solution metering apparatus having temperature sensing function according to claim 1, wherein the equivalent resistor is a long lead circuit or a high-resistance circuit.

7. The solution metering apparatus having temperature sensing function according to claim 1, wherein the temperature sensing member is electrically connected to the first sensing member or the second sensing member.

8. A solution metering apparatus having temperature sensing function for measuring the physical state of solution in a vessel, comprising:
a substrate;
a sensor layer, consisting of a first sensing member and a temperature sensing member, wherein a second sensing member being disposed on the outer surface of the vessel the first sensing member and the second sensing member disposed on the vessel form capacitance effect, the temperature sensing member being made of equivalent resistor material, the sensor layer being disposed on one side surface of the substrate; and
a protective layer overlying the sensor layer.

9. The solution metering apparatus having temperature sensing function according to claim 8, wherein the sensor layer measures any of the following signals: capacitance, inductance and impedance.

10. The solution metering apparatus having temperature sensing function according to claim 8, further comprising a connector, the connector linking the signal generated by the first sensing member, the second sensing member, or the temperature sensing member to the exterior.

11. The solution metering apparatus having temperature sensing function according to claim 8, wherein the protective layer envelops the entire substrate and the outer surface of sensor layer.

12. The solution metering apparatus having temperature sensing function according to claim 8, further comprising a shield layer, the shield layer being a metal conductive layer and electrically grounded, and disposed on another side surface of the substrate opposing the sensor layer.

13. The solution metering apparatus having temperature sensing function according to claim 8, wherein the equivalent resistor is a long lead circuit or a high-resistance circuit.

14. The solution metering apparatus having temperature sensing function according to claim 8, wherein the temperature sensing member is electrically connected to the sensing member.
